(19) United States
(12) Patent Application Publication
(10) Pub. No.: US 2020/0058030 A1
(43) Pub. Date: Feb. 20, 2020

(54) REDUCING "DECLINED" DECISIONS WITH SMART AGENT AND ARTIFICIAL INTELLIGENCE

(71) Applicant: Brighterion, Inc., Purchase, NY (US)

(72) Inventor: Akli Adjaoute, Mill Valley, CA (US)

(73) Assignee: Brighterion, Inc., Purchase, NY (US)

(21) Appl. No.: 16/663,452

(22) Filed: Oct. 25, 2019

Related U.S. Application Data
(63) Continuation of application No. 15/879,702, filed on Jan. 25, 2018.
Application No. 15/879,702 is a continuation-in-part of application No. 14/690,380, filed on Apr. 18, 2015, now abandoned.

(51) Int. Cl. G06Q 20/40; G06N 20/00; G06N 5/04

(52) U.S. Cl. CPC G06Q 20/4016; G06Q 20/409; G06N 5/04; G06N 20/00

(57) ABSTRACT

An artificial-intelligence based, authorization data processing system and method that use networked electronic computers are provided. Included are one or more smart agent data structures tasked to individually follow past transaction data and behaviors, and to provide its artificial intelligence observations on the magnitude, type, and quality of payment card revenues and business routinely engaged in by the individual, e.g., a cardholder whose transaction request is pending. The computed level of acceptable transaction risk is raised in proportion to the cardholder's business value. As a further expedient, such quality cardholders may never be subject to a “declined transaction” if the requested payment transaction were less than some liberal minimum to meet an appropriate threshold level.

### CROSS REFERENCE TO RELATED PATENT APPLICATIONS

This application is a continuation-in-part of and claims priority to U.S. patent application Ser. No. 14/690,380, entitled “PAYMENT AUTHORIZATION DATA PROCESSING SYSTEM FOR OPTIMIZING PROFITS OTHERWISE LOST IN FALSE POSITIVES.” filed Apr. 18, 2015, by inventor Akli Adjaoute, the disclosure of which is incorporated herein by reference in its entirety.

### BACKGROUND OF THE INVENTION

### Field of the Invention

The present invention generally relates to electronic authorization data processing systems, typically on distributed networks, and more particularly to using artificial intelligence decision platforms to favor certain authorization requests with approvals because of the disproportionate detrimental effects to possible future gains suffered for false positives relating to eligible transactions.

### Background Art

Artificial intelligence systems have been developed to detect fraud, e.g., credit card fraud, fraud perpetrated by computer hackers, etc. One major problem associated with artificial intelligence based fraud/hacker detection systems is the degree of tolerance (margin of error) one needs to program the systems to account for when issuing an alert or a “declined transaction” signal. When the tolerance is set at a too-lax level, the system will be deemed ineffective. In contrast, when the tolerance level is set at a too-stringent level, too many false alarms will be triggered. In turn, consequentially bad side effects may be generated as a result of too many false alarms.

In the credit/debit card industry, for example, some payment cardholders generate far more economic and other types of benefits for card issuers than do the average cardholder. So fraud-scoring mechanisms that treat all cardholders and transactions the same are wasting substantial business and profits. By one account, eleven percent of accountholders that suffered a false positive “transaction declined” experience did not use the same payment card again for at least three months. Instead, a competitor got the business that would have gone to the card issuer but for the false positive transaction declined experience.

Card issuers using a fraud scoring system alone lose far more business than their risk of approving a seemingly dicey transaction.

When an electronic financial payment authorization data processing system declines a fraudulent transaction, it has done its job, and profits are not lost to fraud. Similarly, when a legitimate transaction is approved, the system has again done its job and no problems arise. But, whenever the financial payment authorization data processing system delivers a false negative, a fraudulent transaction gets authorized. Thus, false negatives are a general problem for electronic data processing systems.

Whenever an authorization data processing system delivers a false positive, a legitimate transaction gets declined. That mistake, however, can have huge intangible and adverse side effects, because the mistake discourages and disappoints legitimate cardholders who may stay away for months and never come back. Typically, legitimate cardholders have too many alternative payment cards available to them to rely on cardholder loyalty alone to generate repeat use. For example, stopping $5 billion in fraud makes no sense if the fraud scoring mechanism drove away $80 billion in profits. And that seems to be the case with conventional financial payment authorization data processing systems.

The consequential behavioral impacts on customers and clients therefore should be factored into transaction authorization decisions, as well as the quality of the system being obstructed. The old saying applies here, “Penny wise and pound foolish.” The invention described and claimed below provides an electronic means to solve the above-identified technological problem.

### SUMMARY OF THE INVENTION

In general, artificial-intelligence based, electronic computer implemented processes and systems of authorizing or declining transactions using one or more smart agents are provided. Such processes typically begin when authorization transaction request data message is received. Then, past transaction data and behaviors are individually profiled by executing an algorithm that builds in one or more smart agent data structures a plurality of corresponding individual smart agents as data, and that stores a plurality of previously received authorization request data messages as data, and that computes the magnitude of desirable transactions previously generated by each cardholder involved in a particular recent payment authorization transaction request data message and that then stores the results as computed value of a corresponding cardholder's past business volume as data. An adjusting step is carried out with respect to an instant level of transaction risk stored as data in the one or more smart agent data structures by executing an algorithm according to a computed value of a corresponding cardholder's past business. As a result, a particular instant payment authorization transaction request data message is answered by executing an algorithm that inserts a transaction approved data message as data in the smart agent data structure in return that depends on an adjustment of the instant level of transaction risk as reflected in a data value of the instant level of transaction risk stored as data. Consequentially, an undesirable transaction-declined transaction signal rate is reduced.

Variants of the above-described embodiment of the invention include, for example: always delivering transaction-approved data messages by executing an algorithm for answering a payment authorization transaction request data message if an underlying transaction amount included in payment authorization transaction request data messages is less than a predetermined minimum amount that is stored as data in a smart agent data structure for a specific cardholder; and adjusting the instant predetermined minimum amount that is stored as data by executing an algorithm to proportion such a computed value of a corresponding cardholder's past business that is stored as data in a smart agent data structure.

In some instance, the one or more smart agent data structures comprise electronic knowledge extracted from historical data from a database.

In another embodiment, an artificial-intelligence based, electronic computer implemented process (or system) is provided for using smart agent data structures instead of using historical data from a database. The process involves: electronically categorizing some particular cardholder accounts as having a profit by executing an algorithm of the smart agent data structures that analyzes activities of business generated that was extracted from earlier transaction reports and compartmentally stored in profiles associated with an instant transaction; and electronically changing a transaction-declined message to a transaction-approved message if executing an algorithm of at least one smart agent data structure detects an instant transaction that involves a particular cardholder account categorized by the algorithm as having a profit.

In some stances, the process does not changing the transaction-declined message to the transaction-approved message if the instant transaction involves more than a predetermined dollar that is stored as a threshold. Similarly, the process may not involve changing the transaction-declined message to the transaction-approved message if the instant transaction includes unique, inconsistent, or impossible attributes or transaction record data points with respect to the particular cardholder account categorized as having a greater profit. Optionally, the process further involves changing the transaction-declined message to a transaction-approved message if the instant transaction is the transaction is expected based on the previous activity.

In a further embodiment, an artificial-intelligence based, electronic computer implemented process is provided for reversing an automated decision to decline a financial action request by using a smart agent data structure instead of historical data in a database. The process involves: electronically summarizing profit values of past business transactions generated solely by an individual payment card that executes an algorithm of the smart agent data structure that collects together past business transactions generated solely by an individual payment card and stores a individualized spending profile; summarizing and recording particular purchasing patterns that executes an algorithm of the smart agent data structure that recognizes a purchasing pattern that is compatible and expected based the individualized spending profile; summarizing and recording configurational characteristics that executes an algorithm of the smart agent data structure that recognizes the distinctive characteristics of any user devices employed in the past business transactions and that that stores a summary of user device recognitions; making a first comparison that executes an algorithm of the smart agent data structure that compares the behavior associated to the device; making a second comparison that executes an algorithm of the smart agent data structure that compares the click stream analytics of the device to similar activities; making a third comparison that executes an algorithm of the smart agent data structure that compares the configurational characteristics of the user devices employed in the past business transactions in the summary of user recognitions to that of an instant business transaction and places a stored result of the third comparison; overriding an automated preliminary transaction-declined decision by executing an algorithm of the smart agent data structure in which any overriding depends on a stored result obtained in any of the first, second, or third comparisons; and communicating by executing an algorithm of the smart agent data structure for transmitting a transaction-approve message through a corresponding financial network.

Other and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is functional block diagram a financial payment authorization data-processing system that includes a message data processor for accepting payment-authorization-transaction-request data messages over a typical secure network from a conventional financial network;

FIG. 2 is functional block diagram of a smart agent data structure of the present invention; and

FIG. 3 is a flowchart diagram illustrating the further data processing required in embodiments of the present invention when a transaction for a particular amount $X has already been preliminarily “declined” according to some other scoring model.

### DETAILED DESCRIPTION OF THE INVENTION

Definitions and Overview

Before describing the invention in detail, it is to be understood that the invention is not generally limited to specific-electronic platforms or types of computing systems, as such may vary. It is also to be understood that the terminology used herein is intended to describe particular embodiments only, and is not intended to be limiting.

Furthermore, as used in this specification and the appended claims, the singular article forms “a,” “an,” and “the” include both singular and plural referents unless the context clearly dictates otherwise. Thus, for example, reference to “a smart agent” includes a plurality of smart agents as well as a single smart agent, reference to “an authorization limit” includes a single authorization limit as well as a collection of authorization limits, and the like

In addition, the appended claims are to be interpreted as reciting subject matter that may take the form of a new and useful process machine, manufacture, and/or composition of matter, and/or any new and useful improvement thereof instead of an abstract idea.

In this specification and in the claims that follow, reference is made to a number of terms that are defined to have the following meanings, unless the context in which they are employed clearly indicates otherwise:

The terms “electronic,” “electronically,” and the like are used in their ordinary sense and relate to structures, e.g., semiconductor microstructures, that provide controlled conduction of electrons or other charge carriers, e.g., microstructures that allow for the controlled movement of holes in electron clouds.

The term “internet” is used herein in its ordinary sense and refers to an interconnected system of networks that connects computers around the world via the TCP/IP and/or other protocols. Unless the context of its usage clearly indicates otherwise, the term “web” is generally used in a synonymous manner with the term “internet.”

The term “method” is used herein in a synonymous manner as the term “process” is used in 35 U.S.C. 101. Thus, both “methods” and “processes” described and claimed herein are considered patent eligible per 35 U.S.C. 101.

The term “smart agent” is used herein as a term of art to refer to specialized technology that differs from prior art technologies that do not involve the use of artificial intelligence and machine learning. In general, the smart agent technology described herein, rather than being pre-programed to try to anticipate every possible scenario or relying on pre-trained models, employs artificial intelligence technology that tracks and adaptively learns the specific behavior of every entity of interest over time. Thus, continuous one-to-one electronic behavioral analysis provides real-time actionable insights and/or warnings. In addition, smart agent technology described herein engages in adaptive learning that continually updates models to provide new intelligence. Furthermore, the smart agent technology solves technical problems associated with massive databases and/or data processing. Experimental data show about a one-millisecond response on entry-level computer servers. Such a speed is not achievable with prior art technologies. Additional differences between the smart agent technology claimed and prior so-called “smart agent” technology will be apparent upon review of the disclosure contained herein. The terms “substantial” and “substantially” are used in their ordinary sense and are the antithesis of terms such as “trivial” and “inconsequential.” For example, when the term “substantially” is used to refer to behavior that deviates from a reference normal behavior profile, the difference cannot constitute a mere trivial degree of deviation. The terms “substantial” and “substantially” are used analogously in other contexts involve an analogous definition.

Smart Agent Technology, a Primer

To describe the invention fully, it is helpful to provide a generalized primer pertaining to describe smart agent technology. Smart agent technology is the only technology that has the ability to overcome the limits of the legacy machine learning technologies allowing personalization, adaptability and self-learning.

Smart agent technology is a personalization technology that creates a virtual representation of every entity and learns/builds a profile from the entity's actions and activities. In the payment industry, for example, a smart-agent is associated with each individual cardholder, merchant, or terminal. The smart agents associated to an entity (such as a card or merchant) learns in real-time from every transaction made and builds their specific and unique behaviors overtime. There are as many smart agents as active entities in the system. For example, if there are 200 million cards transacting, there will be 200 million smart agents instantiated to analyze and learn the behavior of each. Decision-making is thus specific to each cardholder and no longer relies on logic that is universally applied to all cardholders, regardless of their individual characteristics. The smart agents are self-learning and adaptive since they continuously update their individual profiles from each activity and action performed by the entity.

The following are some examples which highlight how the smart agent technology differs from legacy machine learning technologies.

In an email filtering system, smart agents learn to prioritize, delete, forward, and email messages on behalf of a user. They work by analyzing the actions taken by the user and by learning from each. Smart agents constantly make internal predictions about the actions a user will take on an email. If these predictions prove incorrect, the smart agents update their behavior accordingly.

In a financial portfolio management system, a multi-agent system may consist essentially of smart agents that cooperatively monitor and track stock quotes, financial news, and company earnings reports to continuously monitor and make suggestions to the portfolio manager.

Smart agents do not rely on pre-programmed rules and do not try to anticipate every possible scenario. Instead, smart agents create profiles specific to each entity and behave according to their goals, observations, and the knowledge that they continuously acquire through their interactions with other smart agents. Each Smart agent pulls all relevant data across multiple channels, irrespectively to the type or format and source of the data, to produce robust virtual profiles. Each profile is automatically updated in real-time and the resulting intelligence is shared across the smart agents. This one-to-one behavioral profiling provides unprecedented, omni-channel visibility into the behavior of an entity.

Smart agents can represent any entity and enable best-in-class performance with minimal operational and capital resource requirements. Smart agents automatically validate the coherence of the data, perform the features learning, data enrichment as well as one-to-one profiles creation. Since they focus on updating the profile based on the actions and activities of the entity, they store only the relevant information and intelligence rather than storing the raw incoming data they are analyzing, which achieves enormous compression in storage.

Legacy technologies in machine learning generally relies on databases. A database uses tables to store structured data. Tables cannot store knowledge or behaviors. Artificial intelligence and machine learning systems requires storing knowledge and behaviors. Smart agent technologies bring a powerful, distributed file system specifically designed to store knowledge and behaviors. This distributed architecture allows lightning speed response times (below about one millisecond) on entry level servers as well as end-to-end encryption and traceability. The distributed architecture allows for unlimited scalability and resilience to disruption as it has no single point of failure.

### Exemplary Embodiments of the Invention and Associated Contextual Info

Generally, the invention is as a whole based on electronic systems that treats individuals differently according to established behavior of such individuals through the use of smart agents, artificial intelligence and machine learning. As a non-limiting example in the context of credit card payments, if an individual is known to be a traveler, then an authorization request for payment of hotel charges after an authorization for payment from an airline would be subject to a threshold associated with a lower rate of decline than for an individual with no history, recent or past, of travel. Similarly, the threshold for a declined transaction for a particular individual would be higher if the amount for the transaction is trivial when compared with past amounts approved for same individual. In other words, the invention seeks, in some embodiments, to maximize profit in view of past individual transactions in a manner not possible without the use of distributed computer networks with smart agents and specialized artificial intelligence and machine learning programming. In addition, the invention is particularly suited to big data analysis involving, e.g., terrabytes or more of data or billions of transactions.

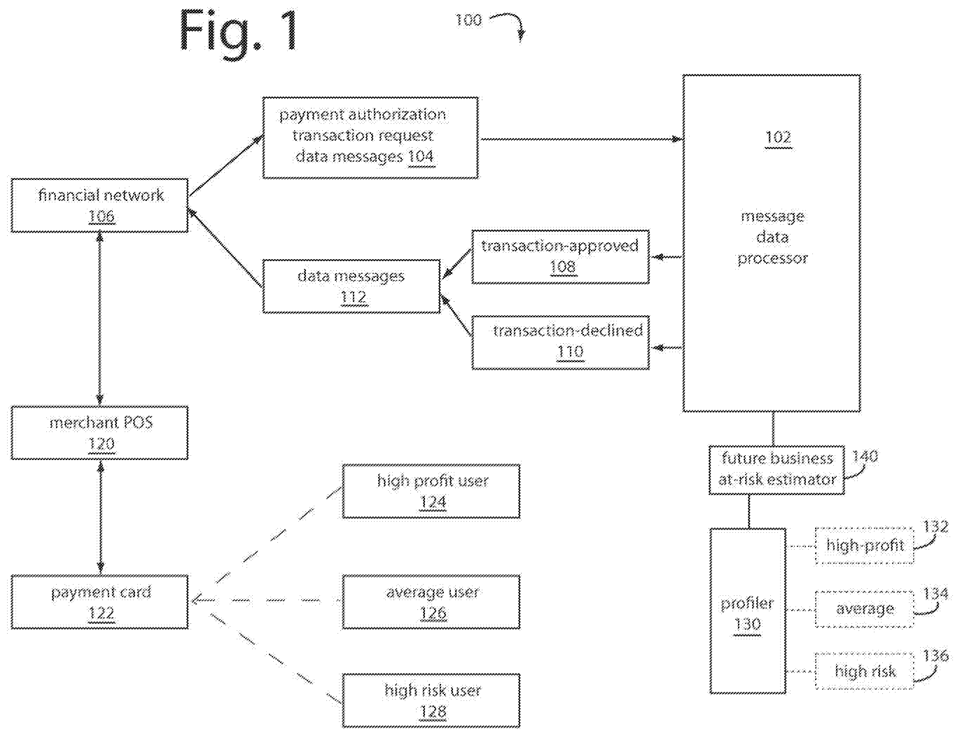

FIG.1 represents a financial payment authorization data-processing system 100 that includes a message data processor 102 for accepting payment-authorization-transaction-request data messages 104 over a typical secure network from a conventional financial network 106. The message data processor 102 also responds in answer with transaction-approved decision 108 or transaction-declined decision 110 encoded in data messages 112. The financial network 106 includes millions of retail merchants of all types that accept payment cards for purchases, wherein a typical one is represented by a conventional merchant point-of-sale (POS) terminal 120.

Conventional payment cards 122 issued by banks and other commercial associations are distributed to at least three types of cardholders, high-profit users 124, average users 126, and high-risk users 128. The high-profit users 124 are those who generate a much higher than average volume of business, and therefore profits, to the banks and other commercial associations.

“Declining” a payment card transaction at any merchant POS terminal 120 has more of a consequence than the immediate consequences of losing the value of the instant transactions. People don't like being “declined”, it's embarrassing, and even a reason to become angry and look for retribution. That is especially true if the reason for declining the transaction is unjustified, silly, capricious, or obscure. Such consequences have traditionally been assumed as a cost of fraud control, technically, false positive indications of fraud when there in fact is no fraud afoot. At worst, these consequences have gone completely unaccounted for and unaddressed.

High profit users 124 have been observed to discontinue using the particular card and card brand that “embarrassed” them for an average of three months. The consequences to profits of losing three months of their business in particular is stunning.

A profiler 130 is used to track all payment card users having ever been responsible for generating a payment-authorization-transaction-request data messages 104. Each are followed and tracked using smart agents. Over time, these payment card users will fall into at least three categories of users: high-profit 132, average 134, and high risk 136. The updating of each payment card user as high-profit 132, average 134, and high risk 136, occurs in real-time and is generally good up to the minute.

In general, the processing of payment card transactions proceeds normally in financial payment authorization data-processing system 100. But, if message data processor 102 is about to respond with a transaction-declined decision 110, a future business at-risk estimator 140 is consulted. Profiler 130 looks in its profiles to see if the particular cardholder involved in the instant payment-authorization-transaction-request data message 104 has been previously categorized as high-profit 132.

If so, the transaction-declined decision 110 is suppressed or completely quashed. Instead, a transaction-approved decision 108 is sent. In one aspect, the transaction-declined decision 110 is suppressed is the computed risk score is unacceptably elevated. In another aspect of the present invention, the transaction-declined decision 110 is always quashed in the transaction dollar volume is below a predetermined threshold, e.g., 20% of average transaction dollar volumes in the last three months for the involved cardholder. Or, if empirical data supports it, any transaction involving a high-profit 132 categorized user will always be approved. The backstop on that is to cancel the payment card 122 when fraud has been proven for a fact later.

The message data processor 102 could be a standard networked data processing system widely used in card payment authorization systems around the world. But if so, they would have to specifically modified and adapted with both hardware and software to accept and work with the future-business at-risk estimator 140 and profiler 130.

The smart agents mentioned above are individual and compartmented data structures “assigned” to follow payment cards 122 as their presence manifests in millions of daily payment-authorization-transaction-request data messages 104. These can be securely maintained in profiler 130 or elsewhere. The present inventor, Dr. Akli Adjaoute, has described these smart agents in various forms in more than a dozen recent USPTO Patent Applications.

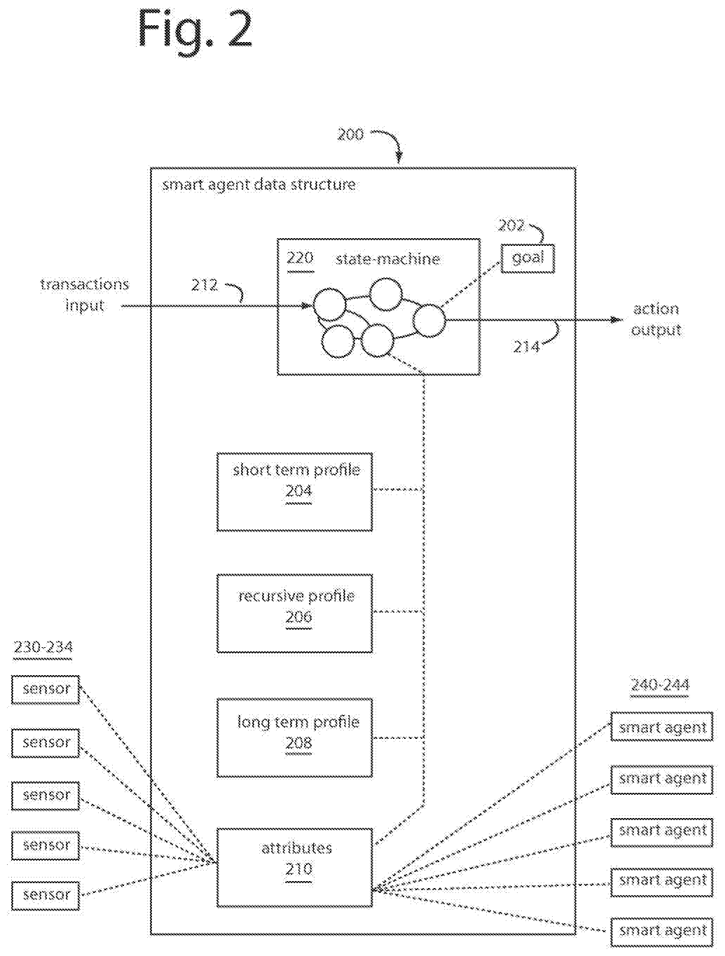

In FIG. 2, numerous smart agent data structures, represented herein by a single smart agent data structure 200, each include a “goal” encoding 202, a short term profile 204, a recursive profile 206, a long term profile 208, and attributes 210 that describe the particular entity 210 that this single smart agent data structure 200 has been assigned to track.

Smart agent data structure 200 will receive distillations of millions of daily payment-authorization-transaction-request data messages 212 that have been cleaned of extraneous data and inconsistencies, enriched by extrapolations and interpolations, and tupled for fast access and interpretation of the payment cards 122 they are “assigned” to follow. (A. “triple” is a data structure that has a specific number and sequence of elements.) These data are moved into corresponding short term profiles 204, recursive profiles 206, and long term profiles 208 by a state machine 220. The state-machine 220 will occasionally or responsively produce an action output 214.

Attributes 210 can be fixed, variable, or programmable. In the case of a payment cardholder entity, a fixed attribute would be a social security number, a biometric, etc. A variable attribute could be slow-changing like a billing address, or fast-changing like a shopping location. Variable attributes could be data obtained from sensors 230-234, like GPS receivers, temperature sensors, light sensors, sound sensors, etc. Programmable attributes can include account numbers, PIN numbers, passwords, expiry dates, etc.

“Unfamiliar” attributes are datapoint tupled from incoming transaction records that are unique to a recent series of transactions. They may also be inconsistent or impossible, like a $512 charge for gasoline. Or a purchase in Europe at near the same time as one in South Dakota, especially if the cardholder has a billing address in Mill Valley, Calif.

Attributes too are usefully assigned their own smart agents 240-244 that link back to attributes 210. For example, an attribute smart agent for billing addresses, can have as its attributes all the addresses of all the cardholder entities with an assigned smart agent data structure 200. It could be quickly determined, if necessary, which cardholders share billing addresses or have ones near others.

State-machine 220 begins its steps through its internal sequences step-by-step as transaction input data 212 is received for it. These sequences routinely squirrel-away the data components in the appropriate triples maintained in short term profiles 204, recursive profiles 206, and long term profiles 208. The action output 214 required by the inputting can be implied to be a score of the behavior for this entity in this transaction as being normal, given their past behaviors manifested in past transaction data. Or it could be a command to decline the transaction, or cancel the payment card altogether.

Goal encoding 202 is a machine-readable way for the state-machine 220 to template the action output 214 about to be produced against a goal or objective like fraud reduction, profit maximization, false positives control, goodwill, etc. It may be necessary for state-machine 220 to have correlation tables that plot goals 202 versus action outputs 214 in order to decide whether or not to issue the looming action output 214. Case based reasoning too can be employed to judge what decisions under which circumstances (attributes) resulted in favorable outcomes.

In a completely different application of smart agent data structures 200, a request by a systems administrator to dump all sensitive cardholder data a personally identifiable information to a single USB thumb drive at 1:30 AM on a Sunday morning could be compared to a goal 202 of data security and denied as an action output 214.

Payment transaction request fraud scoring data structures are, in operation, subject to occasionally falsely scoring a legitimate transaction related to a cardholder by a payment authorization request data message as fraudulent, and that would otherwise be able to deliver a transaction-declined data message in the answer.

In general, embodiments of the present invention rely on a data memory for individually profiling past transaction data and behaviors 122 corresponding cardholders. These are derived from a series of past payment authorization request data messages. An artificial intelligence machine compute and reports its observations on the magnitude, type, and quality of payment card revenues and business routinely engaged in by each cardholder involved in a particular incoming payment authorization transaction request data message. Such includes a means for computing and adjusting an instant acceptable level of transaction risk that is proportioned to a computed value of a corresponding cardholder's past business. Also needed is a mechanism for answering a particular instant payment authorization transaction request data message with a transaction-approved data message that depends on an adjustment of the instant acceptable level of transaction risk.

In certain instances, it would be appropriate to always deliver a transaction-approved data messages in answer to a payment authorization transaction request data message if the underlying transaction amount is less than a predetermined minimum amount. The instant predetermined minimum amount can be proportioned to the computed value of the corresponding cardholder's past business.

Each “channel” of payment mechanism used in electronic financial transactions has its own idiosyncrasies and peculiarities that can mask or obscure fraud. What is also true is most of us are able to “pay” for our purchases in several different ways, each using different channels. For example, checks, credit cards, ACH, debit cards, company cards, and gift cards all represent different channels that can be abused by fraudsters.

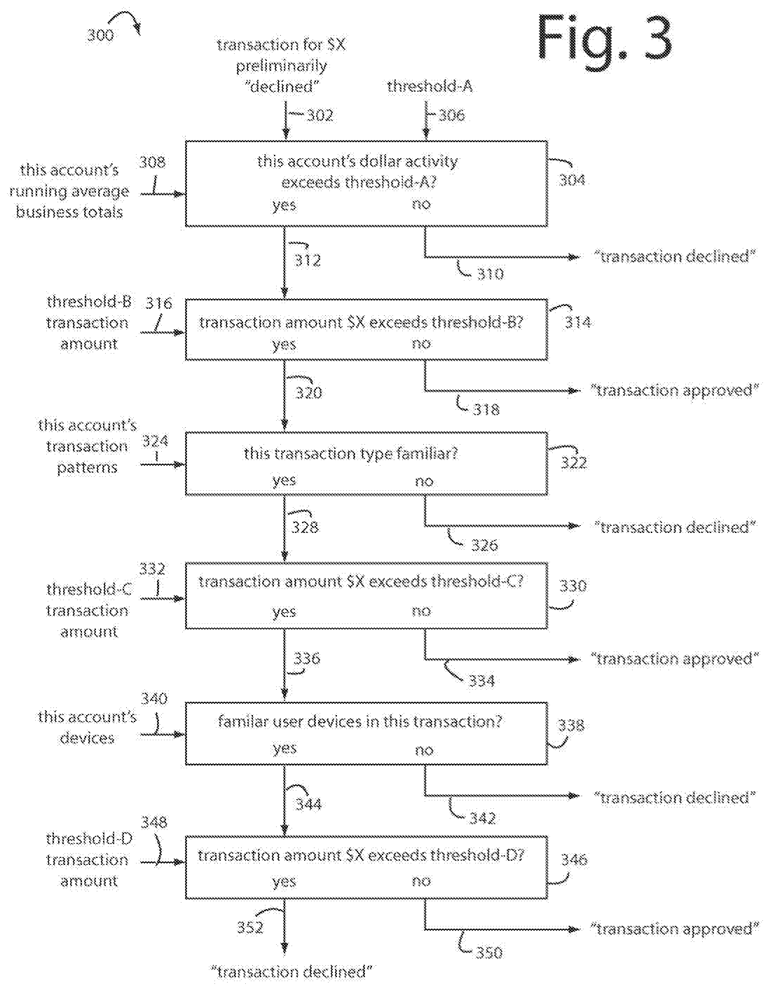

FIG. 3 represents a data structure 300 for the further data processing required in embodiments of the present invention when a payment card transaction for a particular transaction amount $X has already been preliminarily “declined” and included in a decision 302 according to some other scoring model. A test 304 compares a dollar transaction “threshold amount-A” 306 to a computation 308 of the running average business this particular user has been doing with this account involved. The thinking here is that valuable customers who do more than an average amount (threshold-A 306) of business with their payment card should not be so easily or trivially declined. Some artificial intelligence deliberation is appropriate.

If, however test 304 decides that the accountholder has not earned special processing, a “transaction declined” decision 310 is issued as final (transaction-declined 110). Such is then forwarded by the financial network 106 to the merchant POS 120.

But when test 304 decides that the accountholder has earned special processing, a transaction-preliminarily-approved decision 312 is carried forward to a test 314. A threshold-B transaction amount 316 is compared to the transaction amount $X. Essentially, threshold-B transaction amount 316 is set at a level that would relieve qualified accountholders of ever being denied a petty transaction, e.g., under $250, and yet not involve a great amount of risk should the “positive” scoring indication from the “other scoring model” not prove much later to be “false”. If the transaction amount $X is less than threshold-B transaction amount 316, a “transaction approved” decision 318 is issued as final (transaction-approved 108). Such is then forwarded by the financial network 106 to the merchant POS 120.

If the transaction amount $X is more than threshold-B transaction amount 316, a transaction-preliminarily-approved decision 320 is carried forward to a familiar transaction pattern test 322. An abstract 324 of this account's transaction patterns is compared to the instant transaction. For example, if this accountholder seems to be a new parent with a new baby as evidenced in purchases of particular items, then all future purchases that could be associated are reasonably predictable. Or, in another example, if the accountholder seems to be on business in a foreign country as evidenced in purchases of particular items and travel arrangements, then all future purchases that could be reasonably associated are to be expected and scored as lower risk. And, in one more example, if the accountholder seems to be a professional gambler as evidenced in cash advances at casinos, purchases of specific things and arrangements, then these future purchases too could be reasonably associated are be expected and scored as lower risk.

So if the transaction type is not a familiar one, then a “transaction declined” decision 326 is issued as final (transaction-declined 110). Such is then forwarded by the financial network 106 to the merchant POS 120. Otherwise, a transaction-preliminarily-approved decision 328 is carried forward to a threshold-C test 330.

A threshold-C transaction amount 332 is compared to the transaction amount $X. Essentially, threshold-C transaction amount 332 is set at a level that would relieve qualified accountholders of being denied a moderate transaction, e.g., under $2500, and yet not involve a great amount of risk because the accountholder's transactional behavior is within their individual norms. If the transaction amount $X is less than threshold-C transaction amount 332, a “transaction approved” decision 334 is issued as final (transaction-approved 108). Such is then forwarded by the financial network 106 to the merchant POS 120.

If the transaction amount $X is more than threshold-C transaction amount 332, a transaction-preliminarily-approved decision 336 is carried forward to a familiar user device recognition test 338. An abstract 340 of this account's user devices is compared to those used in the instant transaction.

So if the user device is not recognizable as one employed by the accountholder, then a “transaction declined” decision 342 is issued as final (transaction-declined 110). Such is then forwarded by the financial network 106 to the merchant POS 120. Otherwise, a transaction-preliminarily-approved decision 344 is carried forward to a threshold-D test 346.

A threshold-D transaction amount 348 is compared to the transaction amount $X. Basically, the threshold-D transaction amount 348 is set at a higher level that would avoid denying substantial transactions to qualified accountholders, e.g., under $10,000, and yet not involve a great amount of risk because the accountholder's user devices are recognized and their instant transactional behavior is within their individual norms. If the transaction amount $X is less than threshold-D transaction amount 332, a “transaction approved” decision 350 is issued as final (transaction-approved 108). Such is then forwarded by the financial network 106 to the merchant POS 120.

Otherwise, the transaction amount $X is just too large to override a denial if the other scoring model decision 302 was “positive”, e.g., for fraud, or some other reason. In such case, a “transaction declined” decision 352 is issued as final (transaction-declined 110). Such is then forwarded by the financial network 106 to the merchant POS 120.

In general, threshold-B 316 is less than threshold-C 332, which in turn is less than threshold-D 348. It could be that tests 322 and 338 would serve profits better if swapped in FIG. 3. Embodiments of the present invention would therefore include this variation as well. It would seen that threshold-A 306 should be empirically derived and driven by business goals.

The further data processing required by data structure 300 occurs in real-time while merchant POS 120 and users 124, 126, and 128 wait for approved/declined data messages 112 to arrive through financial network 106. The consequence of this is that the abstracts for this-account's-running-average-totals 308, this account's-transaction-patterns 324, and this-account's-devices 340 must all be accessible and on-hand very quickly. A simple look-up is preferred to having to compute the values. The smart agents and the behavioral profiles they maintain and that we've described in this Application and those we incorporate herein by reference are up to doing this job well. Conventional methods and apparatus may struggle to provide these information. Our USPTO patent application Ser. No. 14/675,453, filed, 31 Mar. 2015, and titled, Behavioral Device Identifications Of User Devices Visiting Websites, describes a few ways to gather and have on-hand abstracts for this-account's-devices 340.

The present inventor, Dr. Akli Adjaoute and his Company, Brighterion. Inc. (San Francisco, Calif.), have been highly successful in developing fraud detection computer models and applications for banks, payment processors, and other financial institutions. In particular, these fraud detection computer models and applications are trained to follow and develop an understanding of the normal transaction behavior of single individual accountholders. Such training is sourced from multi-channel transaction training data or single-channel. Once trained, the fraud detection computer models and applications are highly effective when used in real-time transaction fraud detection that comes from the same channels used in training.

Some embodiments of the present invention train several single-channel fraud detection computer models and applications with corresponding different channel training data. The resulting, differently trained fraud detection computer models and applications are run several in parallel so each can view a mix of incoming real-time transaction message reports flowing in from broad diverse sources from their unique perspectives. One may compute a “hit” the others will miss, and that's the point.

If one differently trained fraud detection computer model and application produces a hit, it is considered herein a warning that the accountholder has been compromised or has gone rogue. The other differently trained fraud detection computer models and applications should be and are sensitized to expect fraudulent activity from this accountholder in the other payment transaction channels. Hits across all channels are added up and too many can be reason to shut down all payment channels for the affected accountholder.

In general, a process for cross-channel financial fraud protection comprises training a variety of real-time, risk-scoring fraud model data structures with training data selected for each from a common transaction history to specialize each member in the monitoring of a selected channel. Then arranging the variety of real-time, risk-scoring fraud model data structures after the training into a parallel arrangement so that all receive a mixed channel flow of real-time transaction data or authorization requests. The parallel arrangement of diversity trained real-time, risk-scoring fraud model data structures is hosted on a network server platform for real-time risk scoring of the mixed channel flow of real-time transaction data or authorization requests. Risk thresholds are immediately updated for particular accountholders in every member of the parallel arrangement of diversity trained real-time, risk-scoring fraud model data structures when any one of them detects a suspicious or outright fraudulent transaction data or authorization request for the accountholder. So, a compromise, takeover, or suspicious activity of the accountholder's account in any one channel is thereafter prevented from being employed to perpetrate a fraud in any of the other channels.

Such process for cross-channel financial fraud protection can further comprise steps for building a population of real-time and a long-term and a recursive profile for each the accountholder in each the real-time, risk-scoring fraud model data structures. Then during real-time use, maintaining and updating the real-time, long-term, and recursive profiles for each accountholder in each and all of the real-time, risk-scoring fraud model data structures with newly arriving data. If during real-time use a compromise, takeover, or suspicious activity of the accountholder's account in any one channel is detected, then updating the real-time, long-term, and recursive profiles for each accountholder in each and all of the other real-time, risk-scoring fraud model data structures to further include an elevated risk flag. The elevated risk flags are included in a final risk score calculation 728 for the current transaction or authorization request.

Fifteen-minute vectors are a way to cross pollinate risks calculated in one channel with the others. The 15-minute vectors can represent an amalgamation of transactions in all channels, or channel-by channel. Once a 15-minute vector has aged, it can be shifted into a 30-minute vector, a one-hour vector, and a whole day vector by a simple shift register means. These vectors represent velocity counts that can be very effective in catching fraud as it is occurring in real time.

In every case, embodiments of the present invention include adaptive learning that combines three learning techniques to evolve the artificial intelligence classifiers. First is the automatic creation of profiles, or smart-agents, from historical data, e.g., long-term profiling. The second is real-time learning, e.g., enrichment of the smart-agents based on real-time activities. The third is adaptive learning carried by incremental learning algorithms.

For example, two years of historical credit card transactions data needed over twenty seven terabytes of database storage. A smart-agent is created for each individual card in that data in a first learning step, e.g., long-term profiling. Each profile is created from the card's activities and transactions that took place over the two year period. Each profile for each smart-agent comprises knowledge extracted field-by-field, such as merchant category code (MCC), time, amount for an nice over a period of time, recursive profiling, zip codes, type of merchant, monthly aggregation, activity during the week, weekend, holidays, Card not present (CNP) versus card present (CP), domestic versus cross-border, etc. this profile will highlights all the normal activities of the smart-agent (specific payment card).

Smart-agent technology has been observed to outperform conventional artificial and machine learning technologies. For example, data mining technology creates a decision tree from historical data. When historical data is applied to data mining algorithms, the result is a decision tree. Decision tree logic can be used to detect fraud in credit card transactions. But, there are limits to data mining technology. The first is data mining can only learn from historical data and it generates decision tree logic that applies to all the cardholders as a group. The same logic is applied to all cardholders even though each merchant may have a unique activity pattern and each cardholder may have a unique spending pattern.

A second limitation is decision trees become immediately outdated. Fraud schemes continue to evolve, but the decision tree was fixed with examples that do not contain new fraud schemes. So stagnant non-adapting decision trees will fail to detect new types of fraud, and do not have the ability to respond to the highly volatile nature of fraud.

Another technology widely used is “business rules” which requires actual business experts to write the rules, e.g., if-then-else logic. The most important limitations here are that the business rules require writing rules that are supposed to work for whole categories of customers. This requires the population to be sliced into many categories (students, seniors, zip codes, etc.) and asks the experts to provide rules that apply to all the cardholders of a category.

How could the US population be sliced? Even worse, why would all the cardholders in a category all have the same behavior? it is plain that business rules logic has built-in limits, and poor detection rates with high false positives. What should also be obvious is the rules are outdated as soon as they are written because conventionally they don't adapt at all to new fraud schemes or data shifts.

Neural network technology also limits, it uses historical data to create a matrix weights for future data classification. The Neural network will use as input (first layer) the historical transactions and the classification for fraud or not as an output). Neural Networks only learn from past transactions and cannot detect any new fraud schemes (that arise daily) if the neural network was not re-trained with this type of fraud. Same as data mining and business rules the classification logic learned from the historical data will be applied to all the cardholders even though each merchant has a unique activity pattern and each cardholder has a unique spending pattern.

Another limit is the classification logic learned from historical data is outdated the same day of its use because the fraud schemes changes but since the neural network did not learn with examples that contain this new type of fraud schemes, it will fail to detect this new type of fraud it lacks the ability to adapt to new fraud schemes and do not have the ability to respond to the highly volatile nature of fraud.

Contrary to previous technologies, smart-agent technology learns the specific behaviors of each cardholder and create a smart-agent that follow the behavior of each cardholder. Because it learns from each activity of a cardholder, the smart-agent updates the profiles and makes effective changes at runtime. It is the only technology with an ability to identify and stop, in real-time, previously unknown fraud schemes. It has the highest detection rate and lowest false positives because it separately follows and learns the behaviors of each cardholder.

Smart-agents have a further advantage in data size reduction. Once, say twenty-seven terabytes of historical data is transformed into smart-agents, only 200-gigabytes is needed to represent twenty-seven million distinct smart-agents corresponding to all the distinct cardholders.

Incremental learning technologies are embedded in the machine algorithms and smart-agent technology to continually re-train from any false positives and negatives that occur along the way. Each corrects itself to avoid repeating the same classification errors. Data mining logic incrementally changes the decision trees by creating a new link or updating the existing links and weights. Neural networks update the weight matrix, and case based reasoning logic updates generic cases or creates new ones. Smart-agents update their profiles by adjusting the normal/abnormal thresholds, or by creating exceptions.

Variations of the invention are possible. For example, while the invention has mainly been described in terms of credit/debit card authorizations, the invention may take the form of other application as well. Similarly, while the invention typically involves the use of specialized software with a distributed network of computers, the invention does necessarily involve a huge number of computers; i.e., one supercomputer with many terminals could be used to carry out the invention as well. Persons of ordinary skill in the art will recognize and be enabled to carry out the invention in its various forms by adapting generic and non-generic computers through the use of specialized software and/or firmware in view of the disclosure contained herein. Thus, when the invention is described in terms of process steps, persons of ordinary skill in the art will be able to practice the invention through electronic and/or other means of carrying out the steps through the use of customized and/or off-the-shelf computer components.

Although particular embodiments of the present invention have been described and illustrated, such is not intended to limit the invention. Modifications and changes will no doubt become apparent to those skilled in the art, and it is intended that the invention only be limited by the scope of the appended claims.

What is claimed:

1. At least one payment network computer for supporting payment authorization services, the at least one payment network computer comprising:
one or more processors;
non-transitory computer-readable storage media having computer-executable instructions stored thereon, wherein when executed by the one or more processors the computer-readable instructions cause the one or more processors to
receive, from a merchant point-of-sale device, transaction data corresponding to an authorization request associated with a cardholder entity;
compute a fraud score for the authorization request based on assessment of the transaction data by a scoring model;
generate a preliminarily declined decision for the authorization request based at least in part on the fraud score;
make a special processing determination for the cardholder entity based at least in part on prior transactions of the cardholder entity; and
issue to the merchant point-of-sale device, based at least in part on the special processing determination, a final decision for the authorization request.

2. The at least one payment network computer of claim 1, wherein the final decision declines the authorization request and the special processing determination includes
determining an average of the prior transactions of the cardholder entity,
comparing the average of the prior transactions to a special processing threshold to determine that the cardholder entity is not entitled to special processing.

3. The at least one payment network computer of claim 1, wherein the final decision approves the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is less than the petty transaction threshold.

4. The at least one payment network computer of claim 1, wherein the final decision declines the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is greater than the petty transaction threshold,
analyzing the prior transactions to detect at least one transaction pattern,
comparing the transaction data against the at least one transaction pattern to determine that the transaction data does not correspond to the at least one transaction pattern in a manner that represents reduced risk.

5. The at least one payment network computer of claim 1, wherein the final decision approves the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is greater than the petty transaction threshold,
analyzing the prior transactions to detect at least one transaction pattern,
comparing the transaction data against the at least one transaction pattern to determine that the transaction data corresponds to the at least one transaction pattern in a manner that represents reduced risk,
comparing the transaction amount against a moderate transaction threshold to determine that the transaction amount is less than the moderate transaction threshold.

6. The at least one payment network computer of claim 1, wherein the final decision declines the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is greater than the petty transaction threshold,
analyzing the prior transactions to detect at least one transaction pattern,
comparing the transaction data against the at least one transaction pattern to determine that the transaction data corresponds to the at least one transaction pattern in a manner that represents reduced risk,
comparing the transaction amount against a moderate transaction threshold to determine that the transaction amount is greater than the moderate transaction threshold,
locating user device information from the transaction data,
obtaining account device information for the cardholder entity,
determining that the user device information does not match the account device information.

7. The at least one payment network computer of claim 1, wherein the final decision approves the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is greater than the petty transaction threshold,
analyzing the prior transactions to detect at least one transaction pattern,
comparing the transaction data against the at least one transaction pattern to determine that the transaction data corresponds to the at least one transaction pattern in a manner that represents reduced risk,
comparing the transaction amount against a moderate transaction threshold to determine that the transaction amount is greater than the moderate transaction threshold,
locating user device information from the transaction data,
obtaining account device information for the cardholder entity,
determining that the user device information matches the account device information,
comparing the transaction amount against a substantial transaction threshold to determine that the transaction amount is less than the substantial transaction threshold.

8. The at least one payment network computer of claim 1, wherein the final decision declines the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is greater than the petty transaction threshold,
analyzing the prior transactions to detect at least one transaction pattern,
comparing the transaction data against the at least one transaction pattern to determine that the transaction data corresponds to the at least one transaction pattern in a manner that represents reduced risk,
comparing the transaction amount against a moderate transaction threshold to determine that the transaction amount is greater than the moderate transaction threshold,
locating user device information from the transaction data,
obtaining account device information for the cardholder entity,
determining that the user device information matches the account device information,
comparing the transaction amount against a substantial transaction threshold to determine that the transaction amount is greater than the substantial transaction threshold.

9. Non-transitory computer-readable storage media having computer-executable instructions for supporting payment authorization services, wherein when executed by at least one processor the computer-readable instructions cause the at least one processor to:
receive, from a merchant point-of-sale device, transaction data corresponding to an authorization request associated with a cardholder entity;
compute a fraud score for the authorization request based on assessment of the transaction data by a scoring model;
generate a preliminarily declined decision for the authorization request based at least in part on the fraud score;
make a special processing determination for the cardholder entity based at least part on prior transactions of the cardholder entity; and
issue to the merchant point-of-sale device, based at least in part on the special processing determination, a final decision for the authorization request.

10. The non-transitory computer-readable storage media of claim 9, wherein the final decision declines the authorization request and the special processing determination includes
determining an average of the prior transactions of the cardholder entity,
comparing the average of the prior transactions to a special processing threshold to determine that the cardholder entity is not entitled to special processing.

11. The non-transitory computer-readable storage media of claim 9, wherein the final decision approves the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is less than the petty transaction threshold.

12. The non-transitory computer-readable storage media of claim 9, wherein the final decision declines the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is greater than the petty transaction threshold,
analyzing the prior transactions to detect at least one transaction pattern,
comparing the transaction data against the at least one transaction pattern to determine that the transaction data does not correspond to the at least one transaction pattern in a manner that represents reduced risk.

13. The non-transitory computer-readable storage media of claim 9, wherein the final decision approves the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is greater than the petty transaction threshold,
analyzing the prior transactions to detect at least one transaction pattern,
comparing the transaction data against the at least one transaction pattern to determine that the transaction data corresponds to the at least one transaction pattern in a manner that represents reduced risk,
comparing the transaction amount against a moderate transaction threshold to determine that the transaction amount is less than the moderate transaction threshold.

14. The non-transitory computer-readable storage media of claim 9, wherein the final decision declines the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is greater than the petty transaction threshold,
analyzing the prior transactions to detect at least one transaction pattern,
comparing the transaction data against the at least one transaction pattern to determine that the transaction data corresponds to the at least one transaction pattern in a manner that represents reduced risk,
comparing the transaction amount against a moderate transaction threshold to determine that the transaction amount is greater than the moderate transaction threshold,
locating user device information from the transaction data,
obtaining account device information for the cardholder entity,
determining that the user device information does not match the account device information.

15. The non-transitory computer-readable storage media of claim 9, wherein the final decision approves the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is greater than the petty transaction threshold,
analyzing the prior transactions to detect at least one transaction pattern,
comparing the transaction data against the at least one transaction pattern to determine that the transaction data corresponds to the at least one transaction pattern in a manner that represents reduced risk,
comparing the transaction amount against a moderate transaction threshold to determine that the transaction amount is greater than the moderate transaction threshold,
locating user device information from the transaction data,
obtaining account device information for the cardholder entity,
determining that the user device information matches the account device information,
comparing the transaction amount against a substantial transaction threshold to determine that the transaction amount is less than the substantial transaction threshold.

16. The non-transitory computer-readable storage media of claim 9, wherein the final decision declines the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is greater than the petty transaction threshold,
analyzing the prior transactions to detect at least one transaction pattern,
comparing the transaction data against the at least one transaction pattern to determine that the transaction data corresponds to the at least one transaction pattern in a manner that represents reduced risk,
comparing the transaction amount against a moderate transaction threshold to determine that the transaction amount is greater than the moderate transaction threshold,
locating user device information from the transaction data,
obtaining account device information for the cardholder entity,
determining that the user device information matches the account device information,
comparing the transaction amount against a substantial transaction threshold to determine that the transaction amount is greater than the substantial transaction threshold.

17. A computer-implemented method for supporting payment authorization services comprising, via one or more transceivers and/or processors:
receiving, from a merchant point-of-sale device, transaction data corresponding to an authorization request associated with a cardholder entity;
computing a fraud score for the authorization request based on assessment of the transaction data by a scoring model;
generating a preliminarily declined decision for the authorization request based at least in part on the fraud score;
making a special processing determination for the cardholder entity based at least in part on prior transactions of the cardholder entity; and
issuing to the merchant point-of-sale device, based at least in part on the special processing determination, a final decision for the authorization request.

18. The computer-implemented method of claim 17, wherein the final decision approves the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is less than the petty transaction threshold.

19. The computer-implemented method of claim 17, wherein the final decision approves the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is greater than the petty transaction threshold,
analyzing the prior transactions to detect at least one transaction pattern,
comparing the transaction data against the at least one transaction pattern to determine that the transaction data corresponds to the at least one transaction pattern in a manner that represents reduced risk,
comparing the transaction amount against a moderate transaction threshold to determine that the transaction amount is less than the moderate transaction threshold.

20. The computer-implemented method of claim 17, wherein the final decision approves the authorization request and the special processing determination includes
determining an average of the prior transactions of the cardholder entity,
comparing the average of the prior transactions to a special processing threshold to determine that the cardholder entity is entitled to special processing,
obtaining a transaction amount from the transaction data,
comparing the transaction amount against a petty transaction threshold to determine that the transaction amount is greater than the petty transaction threshold,
analyzing the prior transactions to detect at least one transaction pattern,
comparing the transaction data against the at least one transaction pattern to determine that the transaction data corresponds to the at least one transaction pattern in a manner that represents reduced risk,
comparing the transaction amount against a moderate transaction threshold to determine that the transaction amount is greater than the moderate transaction threshold,
locating user device information from the transaction data,
obtaining account device information for the cardholder entity,
determining that the user device information matches the account device information,
comparing the transaction amount against a substantial transaction threshold to determine that the transaction amount is less than the substantial transaction threshold.
